(19) United States
(12) Patent Application Publication
(10) Pub. No.: US 2026/0193840 A1
(43) Pub. Date: Jul. 9, 2026

(54) A METHOD FOR REMOVING NON-PROCESS ELEMENTS IN A KRAFT PULPING PROCESS

(71) Applicant: VALMET AB, Sundsvall (SE)

(72) Inventors: Camilla KARLEMO, Tampere (FI); Martin WIMBY, Torslanda (SE); Claus JENSEN-HOLM, Virum (DK); Sonja ENESTAM, Västanfjärd (FI); Mats NORDGREN, Bromma (SE)

(73) Assignee: VALMET AB, Sundsvall (SE)

(21) Appl. No.: 19/133,322

(22) PCT Filed: Nov. 7, 2023
(86) PCT No.: PCT/SE2023/051125

§ 371 Date: May 28, 2025

(30) Foreign Application Priority Data
Nov. 30, 2022 (SE) 2230392-9

(51) Int. Cl. D21C 11/00; D21C 11/04

(52) U.S. Cl. CPC D21C 11/0071; D21C 11/0078; D21C 11/04

(57) ABSTRACT

A method for removing one or more non-process elements (NPE) in a Kraft pulping process in a Kraft pulp mill, the method comprising using NaHCO₃ derived from a green liquor H₂S stripping process to solubilize non-process elements (NPE) accumulated in a lime cycle process in the Kraft pulp mill and removing the solubilized one or more non-process elements from the lime cycle process.

### TECHNICAL FIELD

The disclosure pertains to a method for removing one or more non-process elements, NPE, in a Kraft pulping process in a Kraft pulp mill. The disclosure is particularly concerned with counteracting build-up of phosphorous in the lime cycle of a Kraft pulping process in a Kraft pulp mill.

### BACKGROUND

In the operation of pulp mills, there is an ongoing effort to become more environmentally friendly and sustainable. This leads to ambitious goals being set, such as zero waste mills and fossil-free mills. These greener choices come with a cost. The decreased removal of effluent streams and the increase in NPEs which are introduced in the process cycles of the mills due to usage of limekiln biofuels lead to an accumulation of NPEs, such as phosphorous, vanadium and sulphur in the process.

One of the more troublesome non-process elements in the recovery cycle is phosphorous, P. Phosphorous enters the Kraft pulp mill mainly from the wood raw material and from lime kiln fuel if biofuel is used. Make-up lime can also contain some trace amounts of phosphorous if the pulp mill uses low-quality makeup lime.

Phosphorous typically accumulates in lime mud, mostly in the form of calcium phosphate compounds, such as hydroxyapatite Ca5(PO4)3(OH). The phosphorous which is bound in the lime mud, reduces the reactivity of the lime in the lime cycle of the pulp mill. Phosphorous has been shown in numerous mills to be the major contributor of dead load. One weight percent of phosphorous can bind five weight percent of active calcium oxide (CaO), which reduces the amount of available calcium oxide in a lime cycle process and thereby contributes to an increase in inert dead load. Increased dead load also increases the energy consumption in a lime kiln burner.

The methods for removal of Phosphorous are limited because Phosphorous accumulates in white liquor and lime mud and is very soluble in green liquor. Purging lime mud from circulation is one way of getting rid of Phosphorous easily. Phosphorous can also be removed from the electrostatic precipitator (ESP) ashes of a lime kiln in the lime cycle.

An object of the present invention is to offer an improved and economical way of removing accumulated non-process elements such as phosphorous from a Kraft pulping process. A further object is to reduce the amount of make-up lime needed in a lime cycle in a Kraft pulping process.

### SUMMARY

One or more of the above and further objects may be achieved with a method for removing non-process elements according to claim 1. Variations of the disclosure are set out in the dependent claims.

The method for removing one or more non-process elements, NPE, in a Kraft pulping process in a Kraft pulp mill comprises:
subjecting a green liquor to a H₂S stripping process, conveying Na₂CO₃ derived from the H₂S stripping process to a carbonator;
producing NaHCO₃ in the carbonator from the Na₂CO₃ derived from the H₂S stripping process;
conveying NaHCO₃ produced from the Na₂CO₃ derived from the H₂S stripping process to a lime cycle process in the Kraft pulp mill;
mixing an aqueous solution of NaHCO₃ produced from the Na₂CO₃ derived from the H₂S stripping process with lime mud and/or ESP ash to solubilize non-process elements accumulated in the lime cycle process; and
removing the solubilized one or more non-process elements from the lime cycle process.

The green liquor may be a pre-carbonated green liquor, i.e., a green liquor which has been subjected to pre-carbonation prior to being subjected to the H₂S stripping process.

The sodium/sulphur balance plays an important role in the optimal operation of a Kraft pulp mill. In case sulphur accumulation within the recovery system for cooking chemicals is too high, it is important to have processes that can selectively isolate the chemicals. A sulphide conversion process, SCP, referred to herein as “a green liquor stripping process” or a “H₂S stripping process”, is commonly used in Neutral Semi Sulphite Chemical pulping, NSSC. The green liquor stripping aims at separating sodium and sulphur from the green liquor in the form of sodium sulphide Na₂S, sodium carbonate Na₂CO₃ and a hydrogen sulphide H₂S gas stream. The sulphur compounds may be used to produce sulphuric acid H₂SO₄ and sodium bisulphite NaHSO₃. The sodium carbonate Na₂CO₃ may be used to produce sodium bicarbonate NaHCO₃.

The lime cycle of the Kraft pulp mill comprises a causticizer. In the lime cycle, CaCO₃ from the causticizing process is regenerated to CaO in a lime kiln.

Phosphorous is highly soluble in green liquor. However, in the causticizer, phosphorous dissolved in the green liquor reacts with CaO. The calcium phosphate compounds which are formed in the reactions have very low solubility and are accumulated in the lime mud, making part of the lime unavailable for the slaking reactions taking place in the causticizer.

Non-process elements are removed from the lime cycle process by being removed from lime mud and/or from limekiln electrostatic precipitator ash, also referred to herein as ESP ash. The lime mud and/or ESP ash is treated with an aqueous solution of NaHCO₃ to leach out the phosphorous and other NPE from the lime mud and/or ESP ash. As disclosed herein, at least a part, preferably a major part or all of the NaHCO₃ which is used to solubilize the one or more non-process elements from the lime mud and/or ESP ash in the lime cycle, is obtained by carbonation of Na₂CO₃ derived from H₂S stripping of a green liquor in a Kraft pulping process.

It may be preferred that phosphorous is removed from ESP ash from the limekiln. Phosphorous accumulates in ESP ash and can be efficiently and economically removed as the high concentration of phosphorous in ESP ash allows for phosphorous removal by treating a relatively small amount of material.

In the method as disclosed herein, removal of the solubilized non-process element or non-process elements may comprise precipitation with alkali followed by separation of the precipitated non-process element or non-process elements from the process liquid.

In the method as disclosed herein, removal of the solubilized non-process element or non-process elements may comprise precipitation with lime, followed by separation of the precipitated non-process element or non-process elements from the process liquid. Phosphorous may be removed from lime mud and/or ESP ash by precipitation with NaOH and CaO to form hydroxyapatite which can subsequently be removed from the lime cycle.

In a method as disclosed herein, removal of the solubilized non-process element or non-process elements may comprise precipitation with alkali and/or lime followed by separation of the precipitated non-process element or non-process elements from the process liquid.

In the method as disclosed herein, sodium carbonate, Na₂CO₃, derived from the hydrogen sulphide, H₂S, stripping process is conveyed to a carbonator for carbonating flue gas. Sodium bicarbonate, NaHCO₃, produced in the carbonating process is conveyed to the lime cycle process and is used for solubilizing the one or more non-process elements.

In the method as disclosed herein, the sodium bicarbonate, NaHCO₃, may be added to the lime cycle process as a 0.25 M to 5 M solution of sodium bicarbonate, NaHCO₃. Adding a NaHCO₃ solution to lime mud and/or lime kiln ESP ash will dissolve phosphorous and other NPEs from the solid material. The dissolved phosphorous can thereafter be precipitated back to solid form e.g., by adding an alkaline liquid such as NaOH and a small amount of lime, to form hydroxyapatite.

In the method as disclosed herein, the one or more non-process elements may be phosphorous or may include phosphorous.

In the method as disclosed herein, phosphorous may be effectively removed from limekiln ESP ash and/or lime mud, by mixing the limekiln ESP ash and/or lime mud with a NaHCO₃ solution. As disclosed herein, NaHCO₃ or Na₂CO₃ are compounds which can be used to leach out phosphorous from lime mud or lime kiln ash. The method integrates a sulphide conversion process, such as the green liquor stripping process, with the lime cycle, by utilizing a side stream of NaHCO₃ derived from the green liquor stripping process to leach out phosphorous from limekiln ESP ash and/or lime mud in the lime cycle of a Kraft pulping process.

The green liquor stripping process contains three main process steps: pre-carbonation, H₂S stripping, and carbonation.

In the pre-carbonation step, carbon dioxide reacts with sodium sulphide Na₂S and sodium hydroxide NaOH to produce sodium bisulphide NaHS and sodium carbonate Na₂CO₃.

After pre-carbonation, the pre-carbonated green liquor that consists mainly of Na₂CO₃, NaHS, and a negligible amount of NaHCO₃ is conveyed to a H₂S-stripper.

After the H₂S stripping, the produced Na₂CO₃ is divided into two streams. A first stream is conveyed to a carbonator to produce NaHCO₃ for use in NPE removal in the lime cycle and a second stream is used in the causticizing process in the Kraft pulp mill.

The common way of removing accumulated phosphorous and other NPEs which are captured in the lime cycle in a Kraft pulping process has been by withdrawing and dumping lime mud or limekiln EPS ash containing accumulated NPEs. A further way of disposing of NPEs is by using lime mud as a precoat for dregs filtration. As these NPE removal methods involve removal of lime from the process together with the NPEs, it has been necessary to add make-up lime to compensate for the loss of lime from the process.

The method according to the invention provides improved control of the sulfur balance as well as the phosphorous amount in a Kraft pulping process. By integrating the sulphide conversion process with the causticizing process and the lime cycle, a side stream of the green liquor H₂S stripping process may be used as disclosed herein to improve the quality of limekiln ESP ash and/or lime mud. The lowered phosphorous amount in the lime cycle greatly reduces the need for dumping of lime mud or ESP ash. Further, the need for supplying makeup lime to the mill is reduced. The concentrated phosphorous precipitation product is commercially valuable and can be sold as a fertilizer component.

### BRIEF DESCRIPTION OF THE DRAWINGS

The method as disclosed herein will be further explained hereinafter with reference to the appended drawings wherein:

FIG. 1 shows a diagram of a Kraft pulping process; and

FIG. 2 shows a diagram of a phosphorous leaching process.

### DETAILED DESCRIPTION

Different aspects of the present disclosure will be described more fully hereinafter with reference to the enclosed schematic drawings.

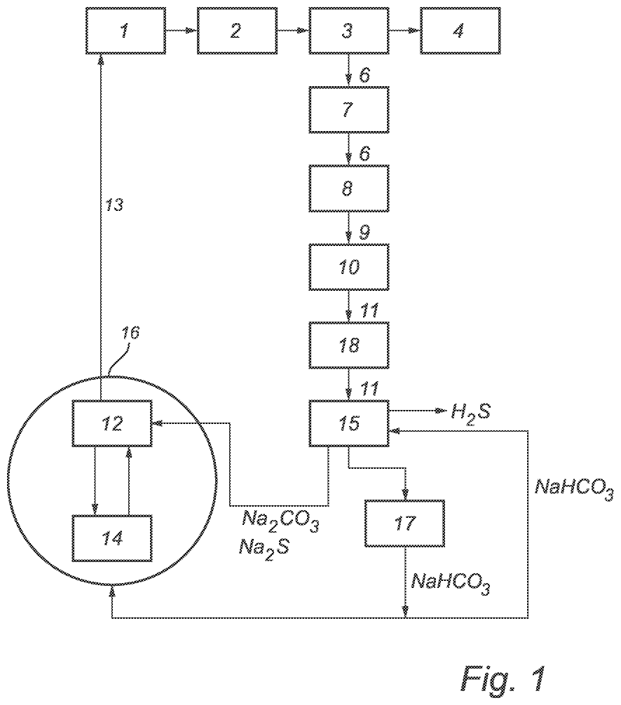

With reference to FIG. 1, there is shown a schematic diagram of a Kraft pulping process, also referred to as a sulphate process. In the Kraft pulping process, wood chips 1 are treated in a digestor 2 with an aqueous cooking liquor, commonly referred to as “white liquor” and containing sodium hydroxide (NaOH) and sodium sulphide (Na₂S). The cooking process breaks the bonds that link lignin, hemicellulose, and cellulose. After cooking, the cellulose fibres are further treated in a pulp production process 3 involving washing, bleaching, and drying to produce cellulose pulp 4.

Process liquid 6, commonly referred to as “black liquor”, is derived from the pulp production process 3, following on the digestor 2. The black liquor 6 is subjected to evaporation in an evaporator 7 where the black liquor 6 from the pulping process is concentrated. The concentrated black liquor 6 is then transferred to a recovery boiler 8.

The liquor flows in the Kraft pulp mill may be referred to as a “cyclic liquor flow system” comprising a main liquor cycle where at least a part of liquor which is used in the digester in the pulp mill is reconditioned and recycled to the digester. The cyclic liquor flow system comprises sub-cycles of liquor flow from different process equipment in the pulp mill. It is also to be understood that water and chemicals are added and withdrawn from the cyclic liquor flow system as part of a chemical recovery system in the pulp mill.

The recovery boiler 8 is part of the recovery system. In the recovery boiler 8, black liquor from the pulping process is burnt to recover chemicals and thermal energy generated by the burning process.

The chemicals are recovered from smelt 9 which is withdrawn from the recovery boiler 8 and is transferred to a dissolving tank 10. The dissolved smelt 9 leaves the dissolving tank as green liquor 11, which is subsequently recausticized in a causticizer 12 and recycled as white liquor 13 to the digester 1 of the Kraft pulp mill. In the causticizer 12, sodium carbonate in the green liquor reacts with burnt lime, CaO:

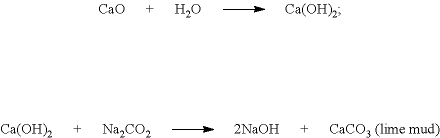

The causticizer 12 is integrated in a lime cycle 16 of the Kraft pulp mill. In the lime cycle 16, CaCO₃ from the causticizing process is regenerated to CaO in a lime kiln 14. Phosphorous is highly soluble in green liquor. In the causticizer 12, phosphorous dissolved in the green liquor 11 reacts with CaO. The calcium phosphate compounds which are formed in the reactions have very low solubility and are accumulated in the lime mud, making part of the lime unavailable for the slaking reactions taking place in the causticizer 12.

As set out herein, it has now been found that phosphorous may be removed from the lime cycle by coupling the lime cycle to a sulphide conversion process, SCP, such as a green liquor H₂S-stripping process to which the green liquor 11 is subjected after leaving the dissolving tank 10. In the H₂S stripper 15, sodium and sulphur are separated from the green liquor 11 in the form of sodium sulphide Na₂S, sodium carbonate Na₂CO₃ and a hydrogen sulphide H₂S gas stream that can be used to produce sulphuric acid H₂SO₄ or sodium bisulphite NaHSO₃. Na₂S and Na₂CO₃ are used in the caustizising process and a part of the Na₂CO₃ from the H₂S stripper 15 is converted to sodium bicarbonate NaHCO₃ in a carbonator 17 using carbon dioxide CO₂ from flue gases generated in the recovery boiler:

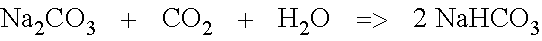

A part of the NaHCO₃ from the carbonator 17 is led back to the H₂S stripper 15 and another part of the NaHCO₃ from the carbonator 17 is led to the lime cycle 16 where it is used for solubilization of NPE, in particular for solubilization of phosphorous.

As shown in FIG. 1, prior to the H₂S stripping, the green liquor 11 may be subjected to an optional pre-carbonation step in a pre-carbonator 18. In the pre-carbonator 18, carbon dioxide CO₂ reacts with sodium sulphide Na₂S and sodium hydroxide NaOH to produce sodium bisulfide NaHS and sodium carbonate Na₂CO₃. After pre-carbonation, the green liquor 11 contains mainly Na₂CO₃, NaHS, and a negligible amount of NaHCO₃ which is conveyed to the H₂S stripper 15.

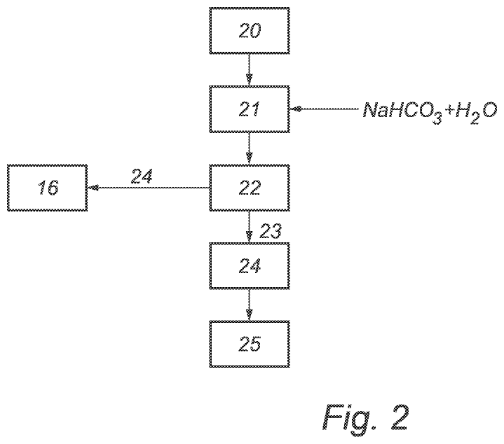

With reference to FIG. 2, showing a phosphorous leaching process, lime mud and/or ESP ash 20 is led to a mixer 21 where it is mixed with a solution of NaHCO₃ and water to solubilize phosphorous from the lime mud and/or ESP ash 20. The liquid phase 23 is separated from the treated lime mud and/or ESP ash 24 in a separator 22 and the treated lime mud and/or ESP ash 24 may be returned to the lime cycle 16. Phosphorous may be separated from the liquid phase 23 by precipitation 25. Precipitation may be carried out by adding an alkaline liquid such as NaOH and a small amount of CaO to form hydroxyapatite which can be removed from the process.

It has been found that treatment of ESP ash is a particularly effective way of removing phosphorous from the lime cycle of a Kraft pulp mill, as phosphorous is concentrated in the ESP ash and can be removed from the lime cycle by treating only a limited amount of material.

The process as disclosed herein counteracts build-up of NPE in the lime cycle of a Kraft pulp mill and reduces the need for dumping of lime mud which has been inactivated by accumulation of phosphorous as well as the need for supplying make-up lime to the lime cycle.

1. A method for removing one or more non-process elements (NPE) in a Kraft pulping process in a Kraft pulp mill, the method comprising:
subjecting a green liquor to a H₂S stripping process,
conveying Na₂CO₃ derived from the H₂S stripping process to a carbonator;
producing NaHCO₃ in the carbonator from the Na₂CO₃ derived from the H₂S stripping process;
conveying NaHCO₃ produced from the Na₂CO₃ derived from the H₂S stripping process to a lime cycle process in the Kraft pulp mill;
mixing an aqueous solution NaHCO₃ produced from the Na₂CO₃ derived from the H₂S stripping process with lime mud and/or ESP ash to solubilize non-process elements (NPE) accumulated in the lime cycle process; and
removing the solubilized one or more non-process elements from the lime cycle process.

2. A method according to claim 1, wherein the green liquor is a pre-carbonated green liquor.

3. A method according to claim 1, wherein the aqueous solution NaHCO₃ produced from the Na₂CO₃ derived from the H₂S stripping process is mixed with ESP ash.

4. A method according to claim 1, wherein removal of the solubilized non-process elements comprises precipitation with alkali followed by separation of the precipitated non-process elements from the process liquid.

5. A method according to claim 1, wherein removal of the solubilized non-process elements comprises precipitation with lime, followed by separation of the precipitated non-process elements from the process liquid.

6. A method according to claim 1, wherein the NaHCO₃ is added to the lime cycle process as a 0.25 M to 5 M solution of NaHCO₃.

7. A method according to claim 1, wherein the non-process elements include phosphorous.
